(19) United States
(12) Patent Application Publication
(10) Pub. No.: US 2006/0085393 A1
(43) Pub. Date: Apr. 20, 2006

(54) Method and system for environmental, health, and safety compliance

(75) Inventor: Keith Richard Modesitt, Blacklick, OH (US)

Correspondence Address: HOUSTON ELISEEVA, 4 MILITIA DRIVE, SUITE 4, LEXINGTON, MA, 02421, US

(73) Assignee: Perillon Software, Inc., Hudson, MA (US)

(21) Appl. No.: 10/955,528

(22) Filed: Sep. 30, 2004

(51) Int. Cl. G06F 17/30

(52) U.S. Cl. 707/3

(57) ABSTRACT

An environmental, health and safety (EH&S) compliance system provides for real-time exchange of EH&S data from various remote and disparate data sources. These sources are typically located within a client's firewall and accessed using a data uploader component. The data are then sent securely to a data importer, which can reside either behind the client's firewall or hosted externally. The importer is the main component that accepts the data from the data uploader. The data importer can also accept data securely from the client's internal system when prohibited by the client's security policy to allow inside the firewall polling. The uploader resides usually behind the client's firewall, typically on a central server and comprises an intuitive user interface and underlying secure architecture to facilitate data transfer. It preferably has a user interface to enable client-side control. The uploader component utilizes the secure data access technologies such as from Microsoft Corporation and other third party providers to connect to and integrate with disparate data sources while utilizing an extensible markup language (XML) Web Service technology to securely transfer data to the importer component. Usually the data are acquired by receiving exported data from third-party system or by interfacing with those systems using application programming interfaces or other access techniques.

### RELATED APPLICATION

This application is related to U.S. application Ser. No. (Attorney docket No.: 0057.0002US1), entitled User Interface for System for Environmental, Health, and Safety Compliance, filed by the same inventor on an even date herewith, this application being incorporated herein in its entirety by this reference.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Sarbanes-Oxley compliance requirements combined with local, state, and federal environmental protection agencies regulations add a large administrative burden to corporate environmental governance staffs. Most companies do not have adequate systems in place to process the massive amount of data that are required to demonstrate compliance in areas such as waste and water management, employee training, sub-surface remediation, air emissions monitoring, and incident management (e.g., spills). Most organizations still rely on manual spreadsheets and home grown databases to collect and store their environmental compliance data. Such systems are expensive to both develop and maintain. Moreover, the systems result in increased corporate risk, ranging from threats to human life, significant fines, poor public relations, and unnecessary labor costs.

To address this challenge, some companies have proposed enterprise software solutions for managing compliance data. The majority of available solutions are directed at maintaining and enhancing custom, point solutions, largely because an alternative information management approach using existing “off-the-shelf” enterprise applications is deemed inadequate. These off-the-shelf packages tend to be rigid and narrowly-focused. Presently, air compliance management is one of the highest growth areas for environmental compliance software solutions, because of the high data management and stringent regulatory requirements.

### SUMMARY OF THE INVENTION

The present invention is directed to an environmental, health and safety (EH&S) compliance system that provides for real-time exchange of EH&S data from various remote and disparate data sources. These sources are typically located within a client's firewall and accessed using a data uploader component. The data are then sent securely to a data importer, which can reside either behind the client's firewall or hosted externally. The importer is the main component that accepts the data from the data uploader. The data importer can also accept data securely from the client's internal system when prohibited by the client's security policy to allow inside the firewall polling.

The uploader resides usually behind the client's firewall, typically on a central server and comprises an intuitive user interface and underlying secure architecture to facilitate data transfer. It preferably has a user interface to enable client-side control. The uploader component utilizes the secure data access technologies such as from Microsoft Corporation and other third party providers to connect to and integrate with disparate data sources while utilizing an extensible markup language (XML) Web Service technology to securely transfer data to the importer component. Usually the data are acquired by receiving exported data from third-party systems or by interfacing with those systems using application programming interfaces or other access techniques.

The transformer utilities convert the integrated compliance data into an XML format. The data are then sent securely from the client's network into the importer using a Web Service, i.e., port 80, secure socket layer (SSL) (port 443), or virtual private network (VPN) technologies. Using this approach, the importer can inter-operate directly with the data source (i.e., Oracle, continuous emission monitoring systems (CEMS), and SAP) and pull the information on a predetermined schedule. Once the data are extracted, the transformer converts the data into a predetermined XML format for the importer to accept securely.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic block diagram of a system for acquiring and storing compliance data from remote data sources according to the present invention;

FIG. 2 is a schematic view showing the components of the inventive data uploader;

FIG. 3 is a flow diagram illustrating the initialization sequence for the data uploader according to the present invention;

FIG. 4 is a flow diagram illustrating the operation of the uploader according to the present invention;

FIG. 5 is a flow diagram illustrating the operation of the inventive data importer; and

FIGS. 6-12 show various screens of the inventive system's user interface.

### DETAILED DESCRIPTION OF THE PREFERRED EMBODIMENTS

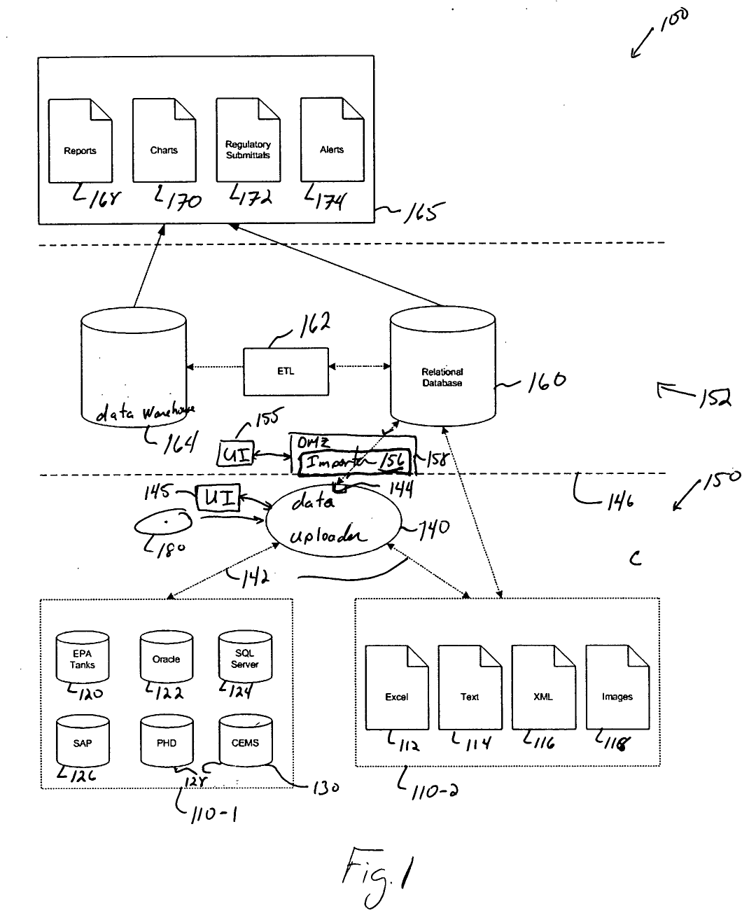

FIG. 1 shows a system 100 for acquiring and storing compliance data, which has been constructed according to the principals of the present invention.

As is common, in many clients' industrial facilities, data are generated and buffered in a large number of disparate, remote data sources, 110-1, 110-2.

In the illustrated example, these remote data sources may be spreadsheet files 112, text files 114, XML files 116, or image files 118 that are stored typically in various locations in the client facility, such as on server or client computers. These remote data files store EH&S compliance data that are required for federal, state and/or local agency reporting systems such as for environmental compliance. Often the data are in a raw form, i.e., not formatted for retrieval by the present system 100.

The compliance data may also be stored at the place of generation, such as the remote CEMS sensor 130 for monitoring smoke stack emissions, or tank leakage sensor 120. Alternatively, the compliance data may also be stored in a Distributed Control System (DCS). Often, these industry-standard instruments will hold data ranging from a few days of data to months of data, depending upon the type and age of the instruments used and the data collection interval.

Alternatively, the compliance data might also be stored on a third party database such as Oracle database 122, or SQL Server 124. The data could also be stored on an enterprise management system such as by a third party enterprise management software system (SAP) 126. Further, the data could also be stored at plant specific Process Historian Databases (PHD) 128. MSAccess database and proprietary formats are other possibilities.

The compliance data from the disparate data sources 110-1, 110-2 are accessed using a data uploader 140. This system is typically connected to the disparate compliance data sources 110-1, 110-2 via a network data connection 142. This can be a TCP/IP network, wireless network, or by a circuit-switched connection such as through the telephone network. That is, remote sensors are sometimes connected to telephone network modems that the uploader dials and then downloads the required data.

In one example, the data uploader 140 is stored on a computer readable medium such as disk 180 that is inserted to the computer intended to run the data uploader 140. The data uploader program is then installed on the computer.

The data uploader 140 acquires the compliance data and then formats the data into a standardized, predetermined form. Usually a standardized template is utilized. Currently, the template is authored in the extensible stylesheet language (XSL). The populated standardized template then is used to generate the data sets that are uploaded from the data uploader 140.

Often the data uploader 140 is running on a client or server computer, which is typically located in the client's facility. In the illustrated example, the client computer executing the uploader 140 uploads the data via a web port or SSL 144, specifically, port 80 or 443. This allows the data to pass through most firewalls and security appliances 146 that may be located between the client portion of the network 150 and an area where the compliance data are stored 152.

The data uploader 140 preferably has a user interface 145. This uploader interface 145 enables client-side control of the uploader such as when the uploader polls the data sources, or how data is uploaded to the importer 156.

In some examples, data center 152 is provided by a service provider that acquires compliance data from multiple clients 150. In other examples, however, this data center 152 is operated by the client itself. Here, the use of the web ports and SSL prevent the need to establish a specific VPN connection to various remote facilities 150 in order to acquire the necessary data sets. Although in some cases, a VPN is implemented, especially where it already exists or is required by an established client security policy.

In the illustrated example, the data sets pass through to a data importer 156. Typically, this is located in a DMZ region of the data center network 152. This DMZ region 158 of the data center network 152 is a location that is less secure and typically carved out by the firewall 146 to allow for the required web communication to the data uploader 140 over the web ports, or otherwise.

The importer 156 receives the various data sets and stores them ultimately into a relational database 160 on the data center network 152. This relational database 160 is then frequently queried by an Extract, Transform, and Load (ETL) process 162, which passes the data to a data warehouse 164. The ETL process is used to extract the necessary compliance data from the relational database 160 into the data warehouse 164 in a form that is optimized for querying and reporting large quantities of compliance data.

The data warehouse 164, is a part of the overall compliance platform of the system 100. It preferably provides extensive reporting capabilities using Online Analytical Processing (OLAP) and data mining features. The data warehouse 164 should manage air, water, and waste data for data aggregation, data mining, and predictive analysis. Specifically, the combined relational database 160 and data warehouse 160 output information 165 that usually takes the form of reports 168, charts 170, regulator agency submittals 172 to state, federal and local agencies, and also alerts 174 that are useful for the management of the remote facility by the management institution for the facilities. The Star Schema is the base design for the data warehouse 164.

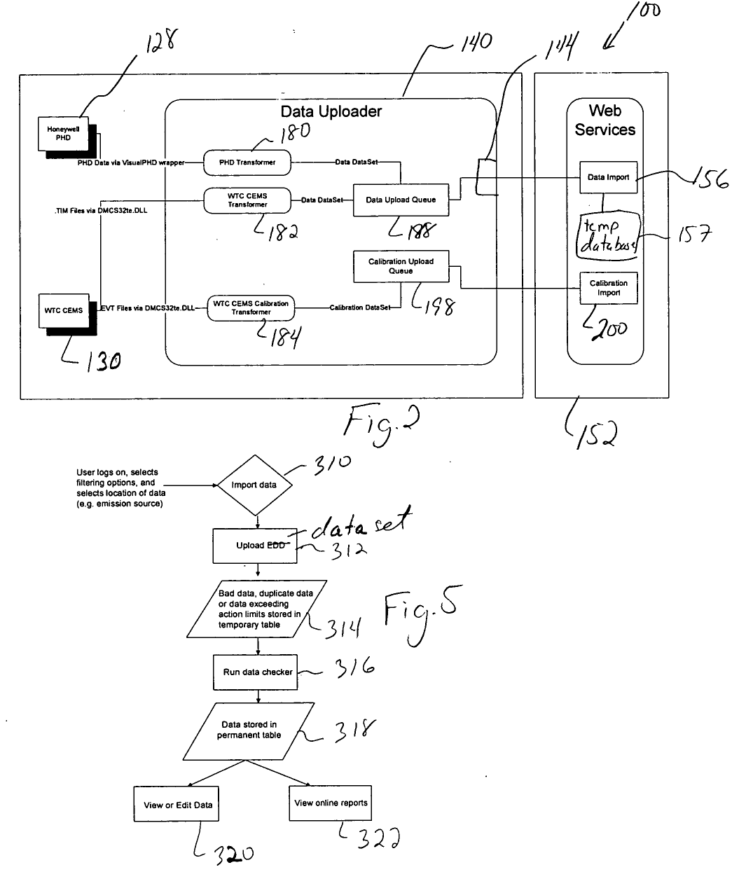

FIG. 2 shows the construction of the data uploader 140. Specifically, in the illustrated example, the data uploader 140 interfaces with a sensor running the Honeywell PHD interface 128. Specifically, a PHD transformer 180 interfaces between a data upload queue 188 and this sensor 128. The PHD transformer 180 interrogates the PHD sensor 128 using the visual PHD wrapper. This allows the PHD transformer to obtain the raw compliance data from the sensor 128.

In a similar vein, WTC-CEMS transformer 182 interfaces with a WTC-CEMS based sensor 130. In this example, the transformer 182 receives the .TIM files using the DMCS32te.dll linked library file. As a result, the WTC-CEMS transformer 182 is able to interrogate the CEMS sensor 130 using its established application programming interface (API) in order to obtain compliance data from this remote data source.

Also shown, is a WTC-CEMS calibration transformer 184. This provides calibration information to and from the CEMS sensor 130. Specifically, this is enabled by an .EVT file using the DMCS32te.dll library that provides the basis for the API of this CEMS sensor 130. The compliance information received by the PHD transformer 180 and the CEMS transformer 182 is used to populate a standardized template, preferably XSL file, to generate corresponding XML data sets, which are transferred to the upload queue 188.

The upload queue 188 then schedules the transmission of these data sets via a web port or other data communication mode, in the preferred embodiment, to the importer 156 in the data center 152.

Similarly, calibration information flows between the data center 152 and sensor 130 via the calibration upload queue 190 and a calibration importer 200, which also resides in the data warehouse 152.

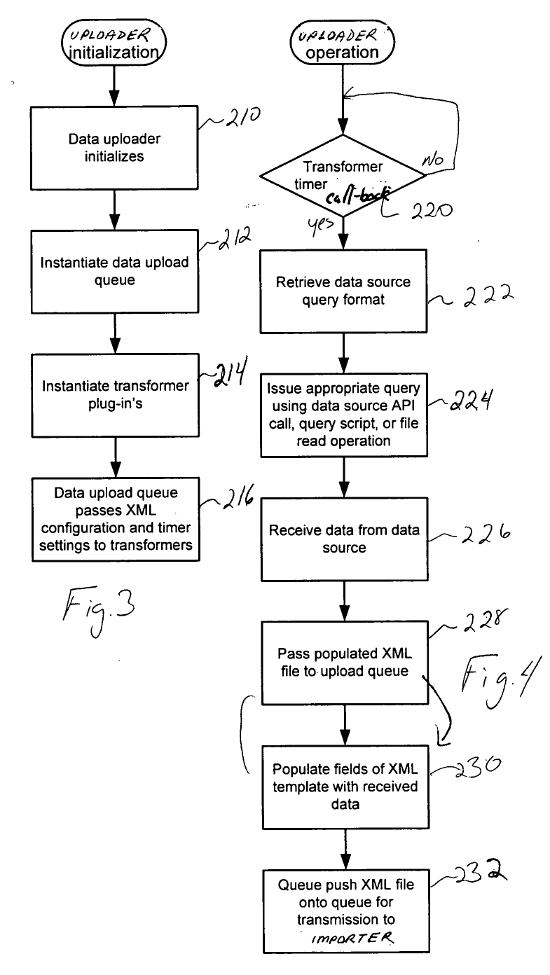

FIG. 3 is a flow diagram illustrating the initialization 210 of the uploader 140.

First, the uploader 140 instantiates the data upload queue 188 in step 212. Then, in step 214, the data uploader 140 reads from a sensor list and instantiates the various required transformer plug-ins.

Specifically in the specific illustrated embodiment of FIG. 2, the PHD transformer 180, the CEMS transformer 182, and the CEMS calibration transformer 184 are instantiated.

Finally, in step 216, the data upload queue 188 passes extensible markup language (XML) configuration information and timer settings to the transformers 180, 182 and 184. This XML configuration information defines and passes the standardized template, preferably XSL file, that the transformers will use to communicate the compliance data to the upload queue 188 so that the data will be in a standardized file format that the upload queue 188 expects. In the preferred embodiment, the template is an XSL template so that the data sets that are transferred from the transformers 180, 182 and 184 to the data upload queue 188 and the calibration upload queue 198 are XML files.

The timer settings that are provided to the transformers 180, 182, 184 to dictate when the various transformers will poll the data from the sensors 128 and 130, for example.

FIG. 4 is a flow diagram illustrating the operation of the uploader 188.

Specifically, the uploader 188 waits in step 220 for a transformer timer to call back in step 220. This call back causes the specific transformer 180, 182 or 184 to poll its corresponding sensor 128, 130 to obtain the compliance data.

The transformer 180, 182, 184 then retrieves the data source query format, in step 222, defining the on the specific interface required to communicate with the sensor 128, 130.

Then, the transformer, in step 224 issues the appropriate query. In one example, this is an API call associated with the sensor data source. In other examples, a query script is used. In still other examples, it is simply a file read operation accessing a file that has been stored at a predetermined location with the file being typically updated periodically by the corresponding sensor.

In step 226, the compliance data are received from the sensor source. The compliance data are then used to populate the XSL file that was received from the upload queue 188 during instantiation of the transformer in step 228. In step 230, the resulting XML file is transferred to the upload queue 188. This upload queue 188 in step 232 pushes the XML file onto the queue for transmission to the importer 156.

FIG. 5 is a flow diagram associated with the data importer 156. Specifically, in step 310, the importer 156 waits for a user log-on, selection of appropriate filtering operations and a location of a desired data such as from an emission source. A user has the ability to ignore any action limits and commit the data if it meets all the uniqueness and referential integrity constraints. However, another user may configure to hold the data in the data checker if there are any action limits to be compared with.

On the selection, in step 312, the data importer 188 uploads the data set from the desired data upload queue 188, 198. Data sets are uploaded using the data set link on the importer user interface (UI) 155. The data sets may be text files (tab or comma delimited) or XML files. The data set formats can be defined by the end user to complement existing systems or can accommodate future regulatory formats defined by State and Federal agencies. Filtering options, data category and file format for the data set to be uploaded are selected on the UI 155. When XML format is selected, a link to the format details is displayed in the UI, allowing the user to open a new window and view the detailed XML format.

Uploader 140 is designed to use Schemas defined by the end user or use Schemas developed by the State and Federal regulatory agencies. Using this process, uploader 140 can meet most current and future electronic compliance requirements. Selecting the Browse button, allows the user to choose a file to upload. Then the user selects the Import File option.

The data importer then in step 314 assesses whether or not the data includes bad data typically by comparing the data to data ranges, or whether the data sets include duplicate data. The importer 156 also determines whether or not the data from the XML data sets indicate data that are exceeding action limits stored in a temporary table that stores this information.

In step 316, the data checker 162 is run on the data sets. Running the data checker 162 performs a quality check on the data in the temporary table. Data in this table represent data that did not pass the quality check when the data were initially entered. Running the data checker enables edits to this data for migration to the permanent database 160 or allows the user to delete records. The data checker performs its operation based on the lowest level selected in the filter hierarchy, enabling data to be checked simultaneously from different users.

Once the compliance data polling process is completed, and the data resides in importer 156 in a temporary database, the next step is to perform compliance intelligence checks on the compliance data based on regulatory and client-specific requirements. These compliance intelligence checks are performed using the same interface which adapts to the type of media being managed such as air, water, and waste.

Once data are loaded into the importer 156, a snap shot of the data can be viewed for any range of source locations and regulatory parameters, dynamically, using importer UI 155. Data anomalies are automatically highlighted on-screen for the user. The client can automatically record reasons for the anomaly by simply selecting a code. The code can be configured by the client user with text to define each code, to save time, and corresponds to each client's permit requirements. This recorded code is stored in the database for later reporting.

Once the temporary data have been uploaded from uploader 140 to importer 156 on a schedule determined by the end user, the temporary data are compared to compliance permit rules, requirements, and client specific requirements. The compliance data are automatically compared to these business/compliance rules with the data not meeting these requirements highlighted for the user to manage. The user has the ability to use codes, as defined by the regulatory requirements, to identify the reason(s) for the potential non-compliance. The codes can be configured depending on the type of media being managed such as air, water, and waste. The user can also configure the calculation engine used on the compliance data. The calculation engine is used to define formulas to be applied to the compliance data based on the monitoring location, type of data, and monitoring frequency. Once all the compliance data, based on media, has been validated against regulatory and permit requirements, the user is able to approve the data for submittal. Throughout the entire data management process, an audit trail is maintained to keep track of all changes to the data so an admin user is able to follow the original data value from the point of generation to the calculated values used for compliance determination. The admin user is then able to print out a complete audit trail for all data collected, transformed, and approved for submittal

The following checks occur when the ETL system 162 runs its data checker process: 1) check for Location Codes (any records that do not match a current location are displayed); 2) check for measurement Types (the user selects the desired type from the UI. Measurement types can be defined by the end user or imported directly from the regulatory agency); 3) check for variances in Action Limit Category (this checks data for out of compliance conditions as defined by the end user or regulatory reporting requirements).

After the user has approved the compliance data for submittal, the compliance data are sent from the temporary database 157 in the importer 156 to the primary database 160 for compliance reporting and further analysis in step 318. Importer 156, using an open Services Oriented Architecture, is designed for other applications to connect to importer 156 for compliance analysis and verification to user-defined regulatory reporting requirements. This open architecture extends importer 156 to complement existing in-house applications and meeting future regulatory requirements for air, water, and waste compliance.

For example, using the open architecture of importer 156, the client is able to connect to the importer 156 architecture and extend the functionality of their current system with the functionality of importer 156. The data import/upload process, along with the data review edit capabilities, can be extended to the client's current system to extend that functionality. The client is also able to extend the open architecture by adding in new reporting requirements and regulatory submittals as required by State and Federal agencies.

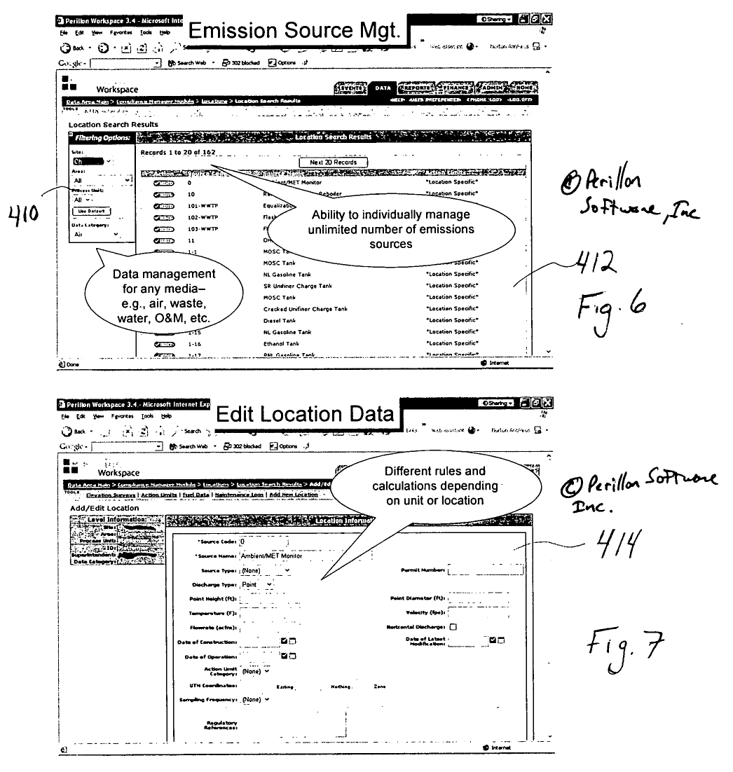

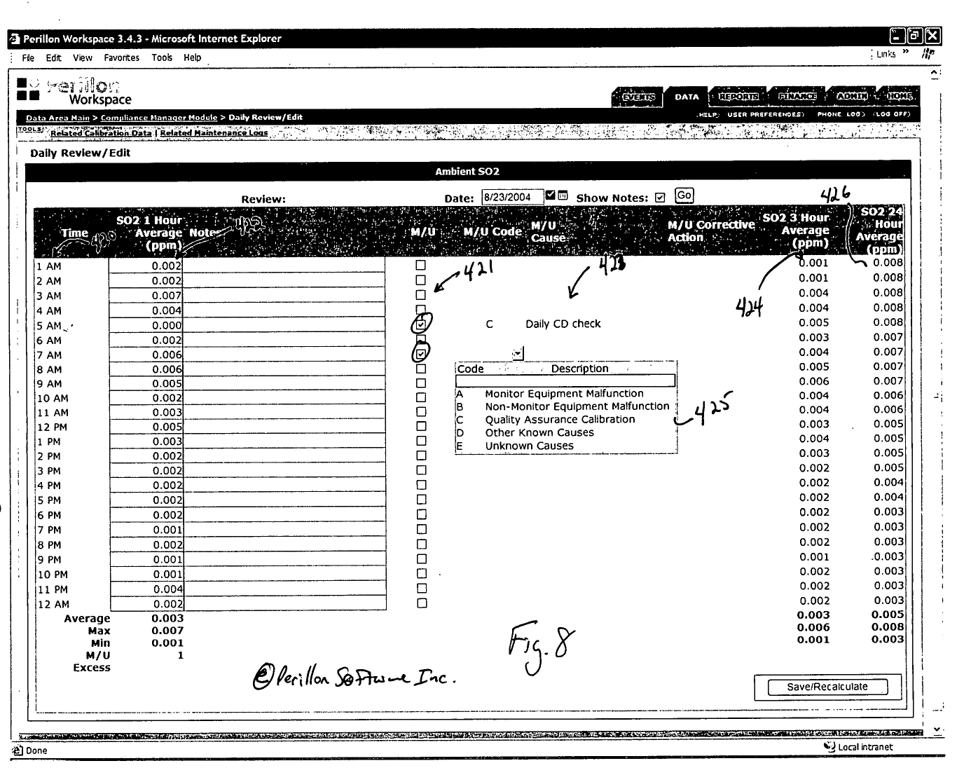

FIG. 6 illustrates a portion of the user interface showing how emission sources can be defined, edited and searched.

Specifically, in the illustrated example, a location search interface is shown providing filtering options are selected in window 410. Specifically, a specific site (“CH”), a specific area, a specific process unit, and a specific data category may be selected in order to filter the data of the set. In the illustrated example, the applied filter has produced 162 records, which are displayed in area 412. This screen includes an ability to edit the associated source code, source name, and action limits associated with this sensor and the corresponding data from the sensor. Generally, the importer 156 hierarchy adapts to the client business operations and thus can have an unlimited number of hierarchy levels.

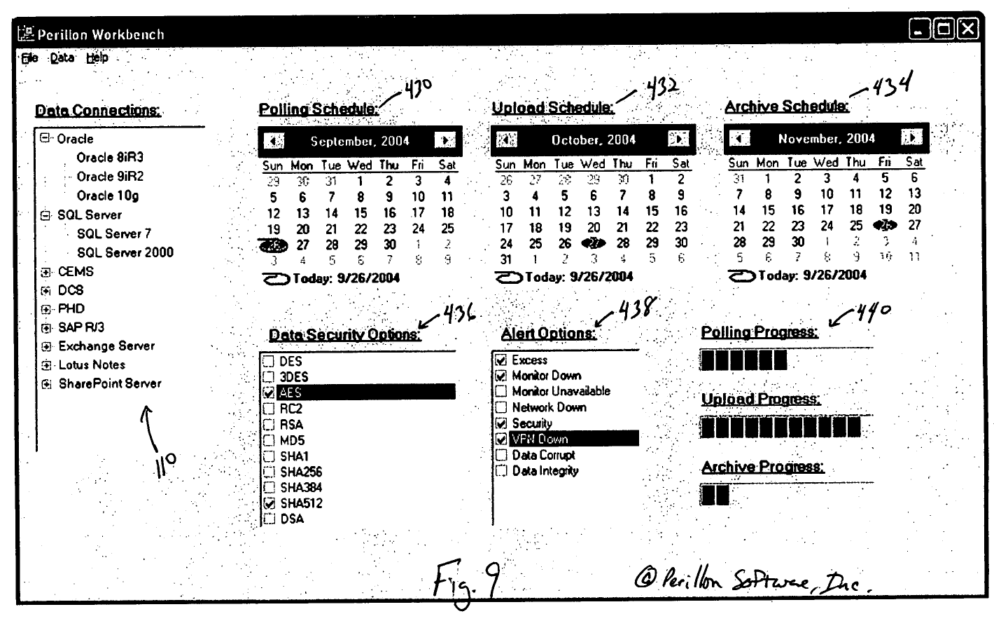

FIG. 7 illustrates the portion of the user interface in which characteristics associated with a specific location or sensor can be defined. Specifically, a source code and source name can be set forth in area 414, including discharge type, point height, temperature, flow rate, date of construction, date of operation, action limit category, permit information, point diameter, velocity and horizontal discharge information. It thus allows specific information to be associated with each sensor/location.

FIG. 8 illustrates a portion of the user interface providing for daily data review and edit. Here, a list of times is provided in column 420. At each of these times, compliance information associated with SO2 averages, parts per million, are provided in column 422. Column 421 indicates whether the compliance data were out of an acceptable range or established compliance limits. Column 423 enables operator recordation of notes associated with a measurement. Specifically, the operator typically enters a reason why the data fell outside the compliance limits. This entry is facilitated by drop-down box 425. Three and 24 hour averages are provided in columns 424 and 426. This allows for quick access to the compliance information for a specific location/sensor.

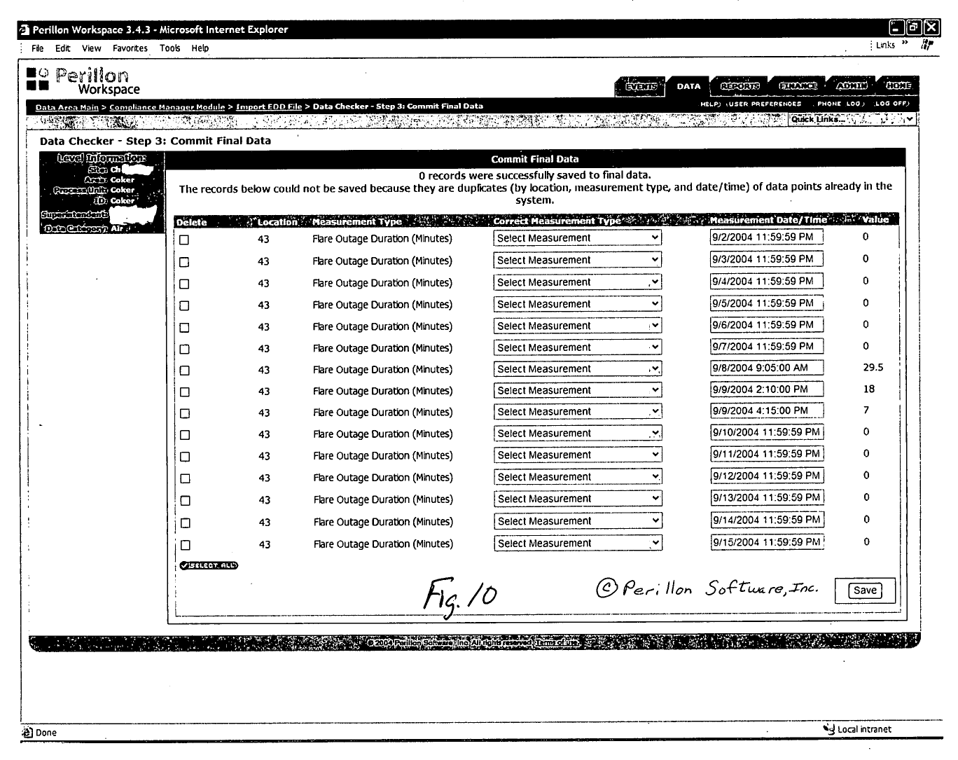

FIG. 9 shows a daily review edit screen of the interface 145 of the uploader 140. A list of installed data sources 110 is provided. Then for designated source specific data are selected for a polling schedule 430, load schedule 432, from uploader 140, an archive schedule 434. Further selection of security options 436 and alert options 438 is provided for. Also, polling/upload status 440 is given.

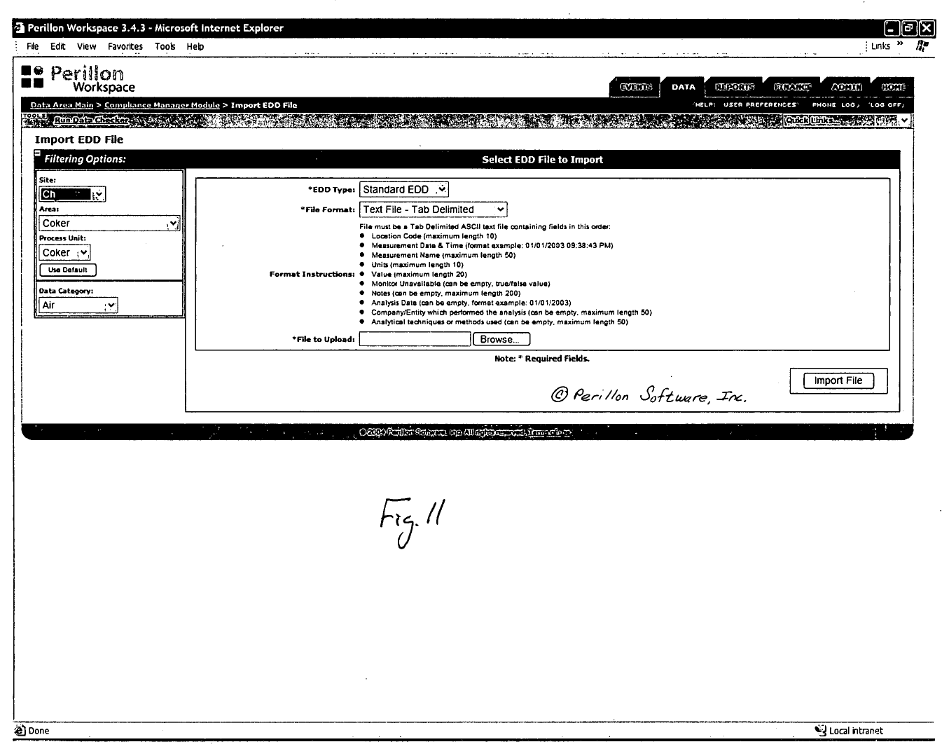

FIG. 10 illustrate the UI illustrating the functioning of the ETL 162. Here, duplicate data is indicated as rejected for a specific site and process unit, and compliance data type.

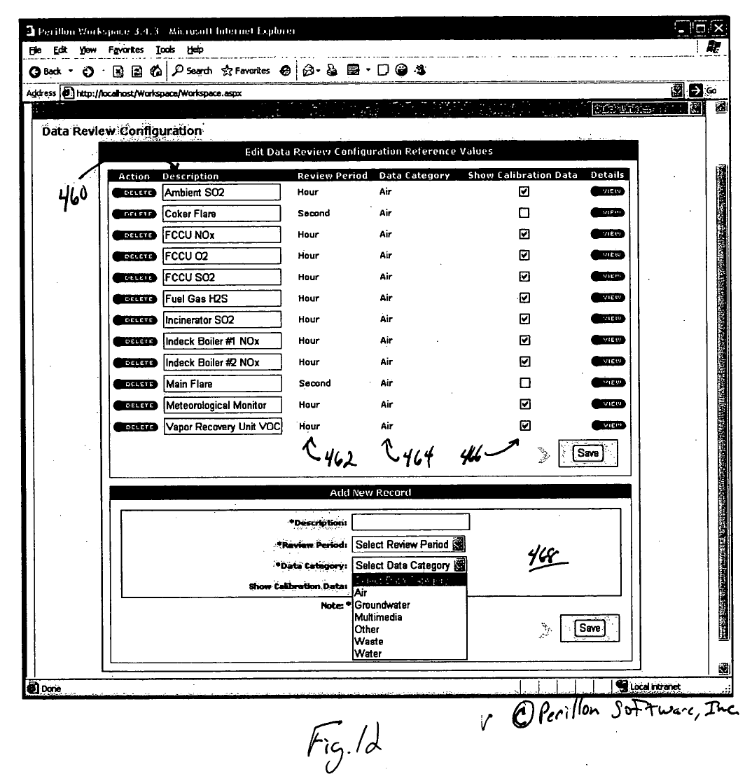

FIG. 11 shows the portion of the UI that enable importation of data set files.

FIG. 12 shows the portion of the UI for data review configuration. Here, in column 460, various data sources from different sensors is specified. A review period is specified in column 462. A data category is specified in column 464. Finally, whether calibration data is shown is designated in column 466. New records are added using area 468.

DataEDDFormat describes the final format of the data as it comes from each of the Data Transformers and is uploaded to the web service by the Data Upload Queue 188.

```
<?xml version=“1.0” standalone=“yes” ? Copyright Perillon
Software, Inc. 2003-2004>
<xs:schema id=“EDDImport” targetNamespace=“http://www.perillon.
com”
xmlns=“http://www.perillon.com”
  xmlns:xs=“http://www.w3.org/2001/XMLSchema”>
  <xs:element name=“EDDImport”>
    <xs:complexType>
      <xs:choice maxOccurs=“unbounded”>
        <xs:element name=“FieldData”>
          <xs:complexType>
            <xs:sequence>
              <xs:element name=“LocationCode”>
                <xs:simpleType>
                  <xs:restriction base=“xs:string”>
                    <xs:maxLength value=“10” />
                  </xs:restriction>
                </xs:simpleType>
              </xs:element>
              <xs:element name=“MeasureDateTime”
              type=“xs:dateTime” />
              <xs:element name=“MeasureName”>
                <xs:simpleType>
                  <xs:restriction base=“xs:string”>
                    <xs:maxLength value=“50” />
                  </xs:restriction>
                </xs:simpleType>
              </xs:element>
              <xs:element name=“MeasureUnits”>
                <xs:simpleType>
                  <xs:restriction base=“xs:string”>
                    <xs:maxLength value=“10” />
                  </xs:restriction>
                </xs:simpleType>
              </xs:element>
              <xs:element name=“MeasureValue”>
                <xs:simpleType>
                  <xs:restriction base=“xs:string”>
                    <xs:maxLength value=“20” />
                  </xs:restriction>
                </xs:simpleType>
              </xs:element>
              <xs:element name=“MonitorDown” type=“xs:boolean”
minOccurs=“0”/>
              <xs:element name=“Notes” minOccurs=“0”>
                <xs:simpleType>
                  <xs:restriction base=“xs:string”>
                    <xs:maxLength value=“50” />
                  </xs:restriction>
                </xs:simpleType>
              </xs:element>
              <xs:element name=“AnalysisDate” type=“xs:date”
minOccurs=“0” />
              <xs:element name=“AnalysisCompany” minOccurs=“0”>
                <xs:simpleType>
                  <xs:restriction base=“xs:string”>
                    <xs:maxLength value=“50” />
                  </xs:restriction>
                </xs:simpleType>
              </xs:element>
              <xs:element name=“AnalysisMethod” minOccurs=“0”>
                <xs:simpleType>
                  <xs:restriction base=“xs:string”>
                    <xs:maxLength value=“50” />
                  </xs:restriction>
                </xs:simpleType>
              </xs:element>
            </xs:sequence>
          </xs:complexType>
        </xs:element>
      </xs:choice>
    </xs:complexType>
  </xs:element>
</xs:schema>
```

UploaderConfiguration.xml is a sample of the xml needed for the runtime configuration of the Upload Queues 188 and the Data Transformers 180, 182.

While this invention has been particularly shown and described with references to preferred embodiments thereof, it will be understood by those skilled in the art that various changes in form and details may be made therein without departing from the scope of the invention encompassed by the appended claims. The same information applied above to air compliance data, is also applied to managing water and waste data for environmental reporting and compliance as determined by State and Federal reporting requirements.

What is claimed is:

1. A method for acquiring and storing compliance data from remote data sources, comprising:
formatting and sending requests to access compliance data from the remote data sources;
receiving the compliance data from the remote sources;
populating a standardized template with the compliance data to generate data sets; and
transmitting and adding the data sets to a database storing compliance data from the remote data sources.

2. A method as claimed in claim 1, wherein the step of formatting and sending the requests comprises accessing application programming interfaces for the remote data sources.

3. A method as claimed in claim 1, wherein the step of formatting and sending the requests comprises formulating and sending query scripts for remote data sources.

4. A method as claimed in claim 1, wherein the step of formatting and sending the requests comprises connecting to a remote file storing the compliance data from the remote data sources.

5. A method as claimed in claim 1, wherein the step of populating the standardized template comprises populating an extensible stylesheet language file.

6. A method as claimed in claim 1, wherein the step of transmitting and adding the data sets comprises transmitting the data sets as a web service through a client firewall and/or security appliance.

7. A method as claimed in claim 1, wherein the step of transmitting and adding the data sets comprises transmitting the data sets over web ports securely.

8. A method as claimed in claim 1, wherein the step of transmitting and adding the data sets comprises transmitting the data sets over a secure socket layer.

9. A method as claimed in claim 1, wherein the step of transmitting and adding the data sets comprises transmitting the datasets to a client administrated database.

10. A method as claimed in claim 1, wherein the step of transmitting and adding the data sets comprises transmitting the datasets to a secure application hosting environment for multiple clients.

11. A method as claimed in claim 1, further comprising checking the data sets for compliance data exceeding action limits.

12. A method as claimed in claim 1, further comprising checking the data sets for duplicate compliance data.

13. A method as claimed in claim 1, further comprising checking the data sets for invalid compliance data.

14. A method as claimed in claim 1, further comprising placing the data sets in a queue for transmission to the database.

15. A system for acquiring and storing compliance data from remote data sources, comprising:
a plurality of transformer modules, in which each one of the modules formats and sends requests to access compliance data from a different one of the remote data sources, receives the compliance data from the remote source, and populates a template with the compliance data to generate data sets;
an upload queue that receives data sets from each one of the plurality of transformer modules and transmits the data sets to a database for storing compliance data from the remote data sources.

16. A system as claimed in claim 15, wherein the transformer modules access application programming interfaces for the remote data sources.

17. A system as claimed in claim 15, wherein the transformer modules formulate and send query scripts for remote data sources.

18. A system as claimed in claim 15, wherein the transformer modules connect to remote files storing the compliance data from the remote data sources.

19. A system as claimed in claim 15, wherein the transformer modules populate the template, which comprises an extensible stylesheet language file.

20. A system as claimed in claim 15, wherein the upload queue transmits the data sets as a web service through a client firewall and/or security appliance.

21. A system as claimed in claim 15, wherein the upload queue transmits the data sets over web ports securely.

22. A system as claimed in claim 15, wherein the upload queue transmits the data sets over a secure socket layer.

23. A system as claimed in claim 15, wherein the upload queue transmits the datasets to a client administrated database.

24. A system as claimed in claim 15, further comprising a data checker that checks the data sets for compliance data exceeding action limits.

25. A system as claimed in claim 15, further comprising a data checker that checks the data sets for duplicate compliance data.

26. A system as claimed in claim 15, further comprising a data checker that checks the data sets for invalid compliance data.

27. A computer software product for acquiring and storing compliance data from remote data sources, the product comprising a computer-readable medium in which program instructions are stored, which instructions, when read by a computer, cause the computer to instantiate:
a plurality of transformer modules, in which each one of the modules formats and sends requests to access compliance data from a different one of the remote data sources, receives the compliance data from the remote source, and populates a standardized template with the compliance data to generate data sets;
an upload queue that receives data sets from each one of the plurality of transformer modules and transmits the data sets to a database for storing compliance data from the remote data sources.
